(19) United States
(12) Patent Application Publication
(10) Pub. No.: US 2026/0094870 A1
(43) Pub. Date: Apr. 2, 2026

(54) LITHIUM BATTERIES INCLUDING ORGANOSULFUR ELECTROLYTES

(71) Applicants: GM GLOBAL TECHNOLOGY OPERATIONS LLC, Detroit, MI (US); UChicago Argonne, LLC, Chicago, IL (US)

(72) Inventors: Meinan He, Birmingham, MI (US); Hasnain Hafiz, Troy, MI (US); William Reginald Collin, Dearborn, MI (US); Michael Dato, Chicago, IL (US); Chi-Cheung Su, Westmont, IL (US); Khalil Amine, Oakbrook, IL (US)

(73) Assignees: GM GLOBAL TECHNOLOGY OPERATIONS LLC, Detroit, MI (US); UChicago Argonne, LLC, Chicago, IL (US)

(21) Appl. No.: 18/905,052

(22) Filed: Oct. 2, 2024

(51) Int. Cl. H01M 10/0568; H01M 10/052; H01M 10/0567; H01M 10/0569

(52) U.S. Cl. CPC H01M 10/0568; H01M 10/052; H01M 10/0567; H01M 10/0569; H01M 2300/0034; H01M 2300/0037

(57) ABSTRACT

Disclosed is product including an electrolyte including a lithium sulfonylimide and a solvent comprising an organosulfur.

### STATEMENT REGARDING FEDERALLY SPONSORED RESEARCH OR DEVELOPMENT

This invention was made with Government support under Agreement No. DOE-OSE964 awarded by the US Department of Energy (DOE). The Government may have certain rights in this invention.

### INTRODUCTION

The technical field generally relates to lithium batteries, components thereof, and methods of making and using the same.

High voltage batteries offer a higher energy density compared to conventional batteries, allowing them to store and deliver more energy for longer durations.

### SUMMARY

A number of variations may include a product including: an electrolyte including a lithium sulfonylimide and a solvent including an organosulfur.

A number of variations may include a product wherein the lithium sulfonylimide has the formula:

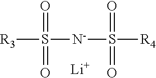

wherein, R4 and R5 are each individually either a fluorine (F) atom or a straight-chain C1-C6 fluoroalkyl group.

A number of variations may include a product wherein the lithium sulfonylimide has the formula of:

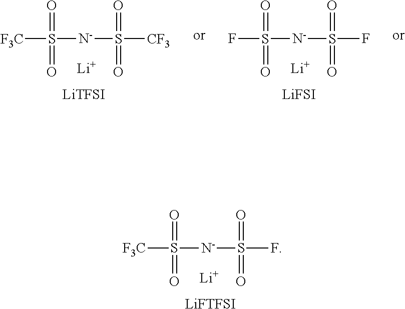

A number of variations may include a product wherein the organosulfur including any one of the following formulas:

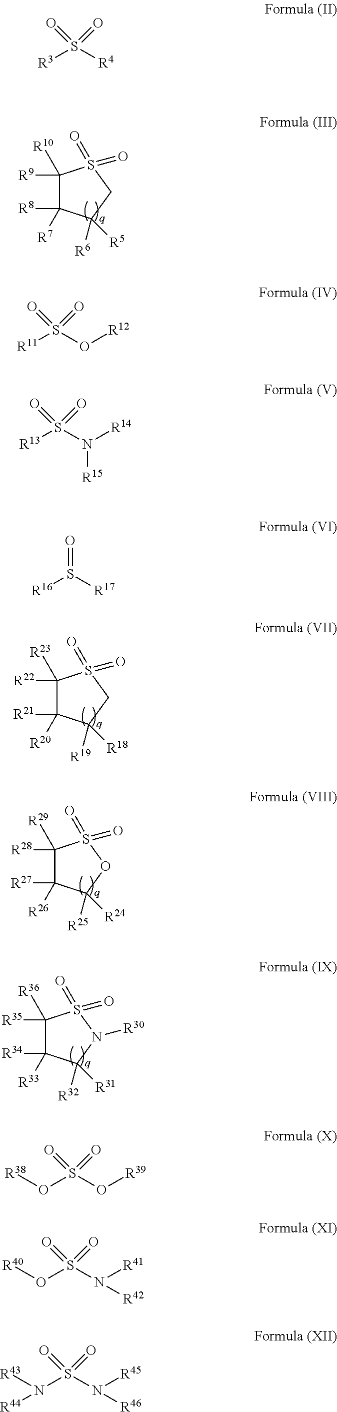

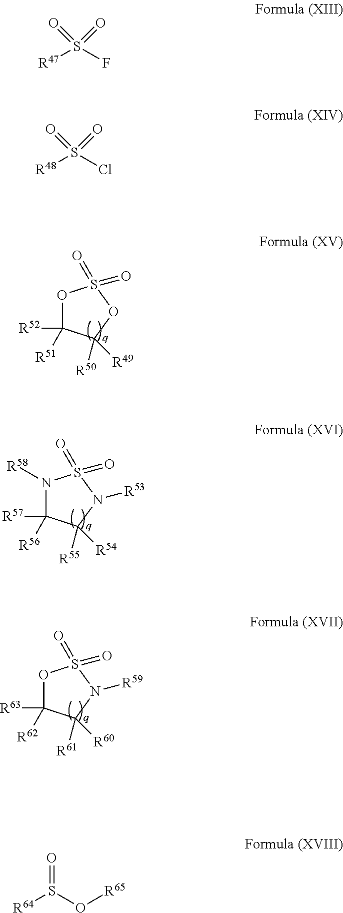

A number of variations may include a product further including an ether or a fluorinated aromatic co-solvent.

A number of variations may include a product further including cyclic carbonate having the formula:

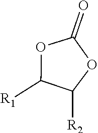

wherein, R1, and R2 are individually a hydrogen atom, or an alkyl or a methoxyl or a vinyl or a propargyl or an alkynyl or a benzyl group or a hydroxyl group, or an alkoxy group, or an alkenoxy group, or an alkynoxy group, or an aryloxy group, or a heterocyclyloxy group, or a heterocyclyalkoxy group; or a silyl group, or an siloxy group; or an oxo group; or a carboxyl group; a ester group; or a ether group; a cyano group, or a cyanoalkyl group; or a fluorine atom; or a fluorinated alkyl group or a fluorinated alkoxy group including CnHxFy or CH2CnHxFy or CH2OCnHxFy or CF2OCnHxFy group, wherein n is 1-5; m is 1-6; x is 0-11; and y is 1-11.

A number of variations may include a product further including at least one of HCF2CF2CH2-O—CF2CF2H or HCF2CH2-O—CF2CF2H.

A number of variations may include a product wherein he organosulfur includes ethyl methyl sulfone.

A number of variations may include a product further including an anti-corrosion additive including at least one of: lithium 4,5-dicyano-2-trifluoromethylimidazole, lithium perchlorate, lithium difluorooxalatoborate, lithium bis(oxalato) borate, lithium tetrafluoroborate, lithium difluoroborate, lithium borate, lithium phosphate, lithium hexafluorophosphate, lithium difluorophsophate, lithium tetrafluorophosphate, lithium difluorooxalatophosphate, lithium tetrafluorooxalatophosphate, lithium tris(oxalato)phosphate, lithium arsenate, lithium hexafluoroarsenate, lithium difluoroarsenate, lithium tetrafluoroarsenate, lithium difluorooxalatoarsenate, lithium tetrafluorooxalatoarsenate, lithium tris(oxalato)arsenate, or their corresponding sodium salts.

A number of variations may include a product including: an electrolyte including lithium sulfonylimide and a solvent including an organosulfur, a co-solvent including an ether or a fluorinated aromatic, a cyclic carbonate, and an anti-corrosion additive.

A number of variations may include a system including: a battery including an anode, cathode, and a separator between the anode and cathode, and an electrolyte; the electrolyte comprising a lithium sulfonylimide and a solvent including an organosulfur.

A number of variations may include a system wherein the lithium sulfonylimide has the formula:

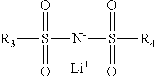

wherein, R4 and R5 are each individually either a fluorine (F) atom or a straight-chain C1-C6 fluoroalkyl group.

A number of variations may include a system wherein the lithium sulfonylimide has the formula of:

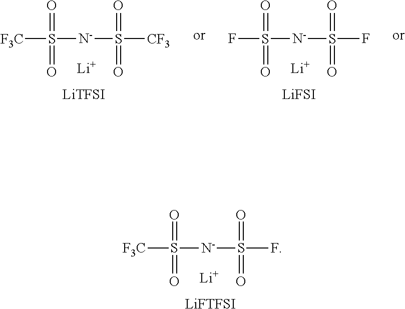

A number of variations may include a system wherein the organosulfur including at least one of:

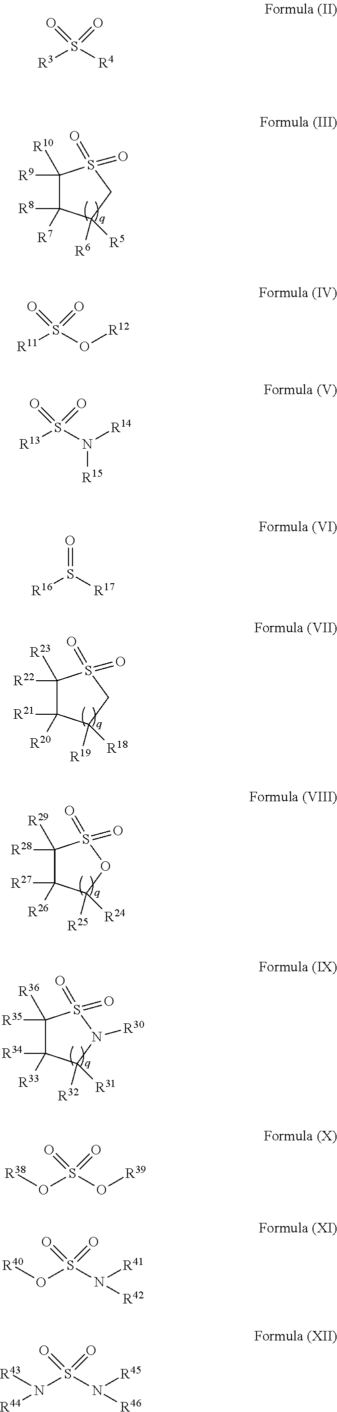

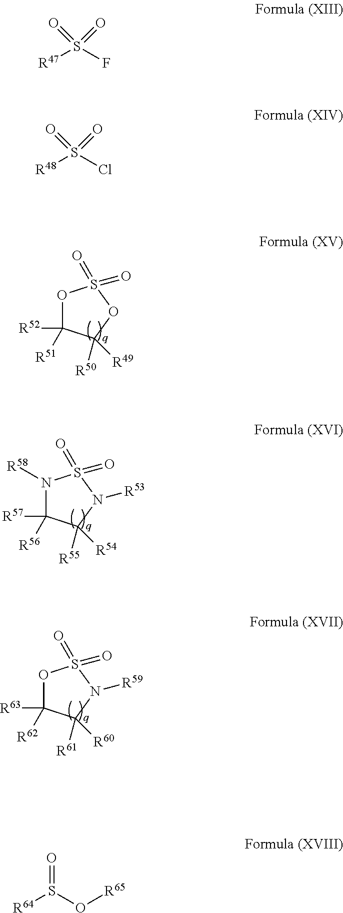

A number of variations may include a system further including an ether or a fluorinated aromatic co-solvent.

A number of variations may include a system further including cyclic carbonate having the formula:

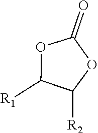

wherein, R1, and R2 are individually a hydrogen atom, or an alkyl or a methoxyl or a vinyl or a propargyl or an alkynyl or a benzyl group or a hydroxyl group, or an alkoxy group, or an alkenoxy group, or an alkynoxy group, or an aryloxy group, or a heterocyclyloxy group, or a heterocyclyalkoxy group; or a silyl group, or an siloxy group; or an oxo group; or a carboxyl group; a ester group; or a ether group; a cyano group, or a cyanoalkyl group; or a fluorine atom; or a fluorinated alkyl group or a fluorinated alkoxy group including CnHxFy or CH2CnHxFy or CH2OCnHxFy or CF2OCnHxFy group, wherein n is 1-5; m is 1-6; x is 0-11; and y is 1-11.

A number of variations may include a system further including at least one of HCF2CF2CH2-O—CF2CF2H or HCF2CH2-O—CF2CF2H.

A number of variations may include a system wherein the organosulfur includes ethyl methyl sulfone.

A number of variations may include a system further including an anti-corrosion additive including at least one of: lithium 4,5-dicyano-2-trifluoromethylimidazole, lithium perchlorate, lithium difluorooxalatoborate, lithium bis(oxalato) borate, lithium tetrafluoroborate, lithium difluoroborate, lithium borate, lithium phosphate, lithium hexafluorophosphate, lithium difluorophsophate, lithium tetrafluorophosphate, lithium difluorooxalatophosphate, lithium tetrafluorooxalatophosphate, lithium tris(oxalato)phosphate, lithium arsenate, lithium hexafluoroarsenate, lithium difluoroarsenate, lithium tetrafluoroarsenate, lithium difluorooxalatoarsenate, lithium tetrafluorooxalatoarsenate, lithium tris(oxalato)arsenate, or their corresponding sodium salts.

A number of variations may include a system further including, a co-solvent including an ether or a fluorinated aromatic, a cyclic carbonate, and an anti-corrosion additive.

### BRIEF DESCRIPTION OF THE DRAWINGS

The illustrative variations will hereinafter be described in conjunction with the following drawing figures, wherein like numerals denote like elements, and wherein:

FIG. 1 is a chart of carbon dioxide generation (μmol) over time of batteries having different electrolytes;

FIG. 2 is a chart of discharge capacity (mAh/g) of batteries having different electrolytes over various cycle numbers;

FIG. 3 is a chart of discharge capacity (mAh/g) over various cycle numbers at different voltages of a 2032 coin cell having an electrolyte including LiPF6;

FIG. 4 is a chart of capacity (mAh/g) over number of cycles at different voltages for a 2.5 Ah pouch cell having an electrolyte including LiPF6;

FIG. 5 is a chart of properties for a battery including electrolytes having a cyclic carbonate, linear carbonate, and a salt;

FIG. 6 is a chart illustrating desirable properties for electrolytes for use in a high-voltage system;

FIG. 7 illustrates the structure of organo-sulfur based solvents as good candidates for high-voltage operation of a battery with low HOMO, high and anodic stability as well as attractive thermal stability;

FIG. 8 illustrates the structure of organo-sulfur based solvents as good candidates for high-voltage operation of a battery with low HOMO, high and anodic stability as well as attractive thermal stability;

FIG. 9 is a chart of ESW (V vs Li/Li+) for various organo-sulfur based solvents;

FIG. 10 is a chart illustrating the discharge capacity (mAh/g) over a number of cycles for electrolyte including 1.2M LiPF6 and various solvents;

FIG. 11 is a chart illustrating the discharge capacity (mAh/g) over a number of cycles for electrolyte including 1.2M LiPF6 and various solvents;

FIG. 12 is a chart illustrating the capacity retention (%) of a 2.5 Ah pouch cell (%) over a number of cycles for a battery including an electrolyte including 1.2M LiPF6 and various solvents;

FIG. 13 the chart illustrating the discharge capacity (mAh/g) mean of four cells over a number of cycles for battery including an electrolyte including 1.2M LiPF6 and various solvents;

FIG. 14 illustrates the capacity (mAh/g) over a number of cycles for batteries including different molar concentrations of LiPF6 with various solvents;

FIG. 15 is a chart of voltage and pressure over time at different voltages for a battery inkling FEC/EMS/TTE/LiFSI;

FIG. 16 is a chart of voltage and pressure over time at different voltages for a battery including FEC/EMS/TTE/LiPF6;

FIG. 17 is a chart illustrating the generation of carbon dioxide (μmol) over time for batteries including different electrolytes for batteries with different electrolytes;

FIG. 18 is a chart illustrating carbon dioxide generation (μmol) over time for batteries including different electrolytes;

FIG. 19 is a chart illustrating the discharge capacity (mAh/g) over a number of cycles for batteries including different molar concentrations of LiPF6 with various solvents and additives;

FIG. 20 is a chart illustrating the capacity retention (%) over a number of cycles for batteries including different electrolytes and additives;

FIG. 21 illustrates a system or product which may include a battery including an electrolyte according to a number of variations; and

FIG. 22 illustrates a system or product which may include a battery including an electrolyte according to a number of variations.

### DETAILED DESCRIPTION

The following detailed description is merely exemplary in nature and is not intended to limit the application and uses. Furthermore, there is no intention to be bound by any expressed or implied theory presented in the preceding introduction, brief description of the drawings, brief summary or the following detailed description.

It has been discovered that, in a lithium battery, replacing some or all of LiPF6 with a sulfonylimide salt may dramatically reduce gas generation, mitigate electrolyte decomposition, and improve cell performance. In a number of variation, the sulfonylimide salt may include at least one of LiFSI (lithium bis(fluorosulfonyl)imide), LiTFSI (lithium bis((trifluoromethyl)sulfonyl)amide), LIFTFSI (lithium (fluorosulfonyl)((trifluoromethyl)sulfonyl)amide) or LiTFMN (lithium trifluoromethanesulfonate). It has been discovered that, in a lithium battery, the additional of at least one organosulfur based solvent improves high voltage operation of lithium batteries with low HOMO, high anodic stability and improved thermal stability. It has been discovered that, in a lithium battery, the addition of at least one of an ether or a fluorinated aromatic co-solvent improves high voltage operation of lithium batteries. It has been discovered that, in a lithium battery, additives may mitigate aluminum or stainless steel corrosion in lithium batteries including a sulfonylimide.

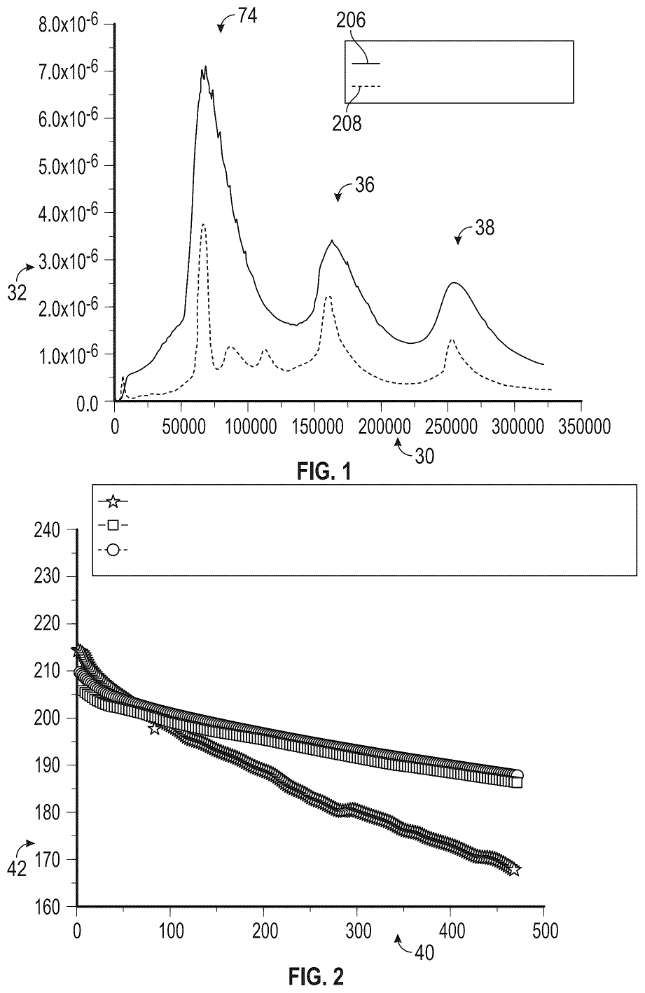

The above stated discovery occurred during a number of studies conducted to discover suitable electrolyte components for high voltage operation of lithium batteries. The some of the results of the studies are illustrated in FIGS. 1-20.

FIG. 1 is a chart of carbon dioxide generation of batteries having different electrolytes over time. The vertical or Y-axis 32 is CO2 (umol) and the horizontal or X-xis is time in seconds. Line 206 represents FEC/EMS/TTE/LiPF6 and line 208 represents FEC/EMS/TTE/LiSI. Carbon dioxide showed peaks in a first cycle 74, second cycle 36, and third cycle 38.

FIG. 2 is a chart of discharge capacity of batteries having different electrolytes over various cycle numbers. The vertical or Y-axis 42 is discharge capacity (mAh/g) and the horizontal or X-axis 40 is number of cycles. The line including a star represents 1.2 M LiPF6 in EC/EMC (Baseline Electrolyte). The line including a square represents 0.8 M LiPF6+0.4 M LiSF in FEC/EMD/TTE (2:5:3 by v)+0.5% LiBOB. The line with a circle represents 0.6 M LiPF6+0.6 M LiSF in FEC/EMD/TTE (2:5:3 by v)+0.5% LiBOB.

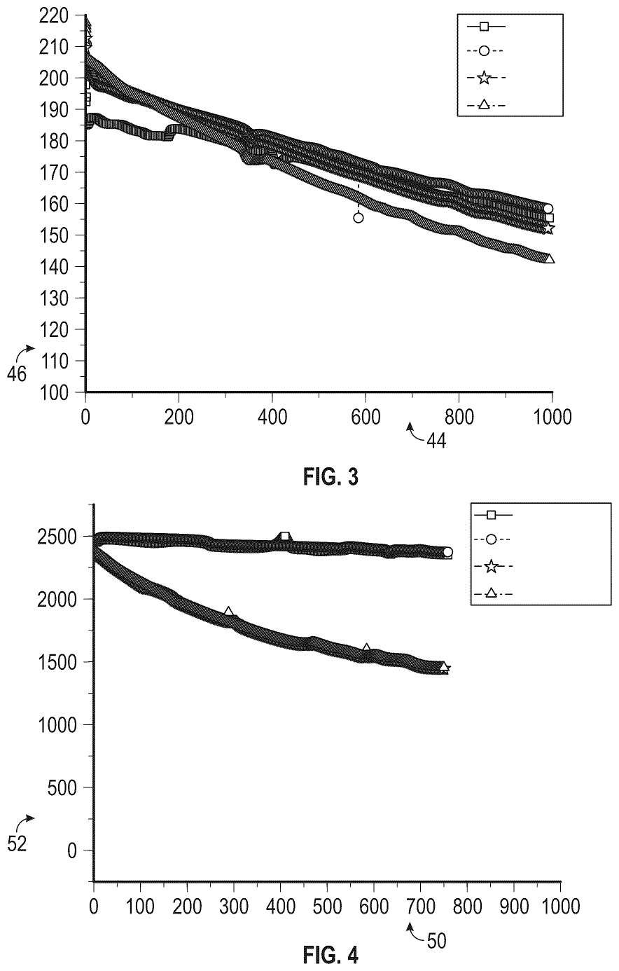

FIG. 3 is a chart of discharge capacity over various cycle numbers at different voltages of a 2032 coin cell having an electrolyte including LiPF6. The vertical or Y-axis 42 is discharge capacity (mAh/g) and the horizontal or X-axis 40 is number of cycles. The line including a square represents 4.2V. The line including a circle represents 4.3V. The line including a star represents 4.4V. The line including a triangle represents 4.5V.

FIG. 4 is a chart of capacity versus number of cycles at different voltages for a 2.5 Ah pouch cell having an electrolyte including LiPF6. The vertical or Y-axis 42 is discharge capacity (mAh/g) and the horizontal or X-axis 40 is number of cycles. The line including a square represents 4.2V. The line including a circle represents 4.3V. The line including a star represents 4.4V. The line including a triangle represents 4.5V.

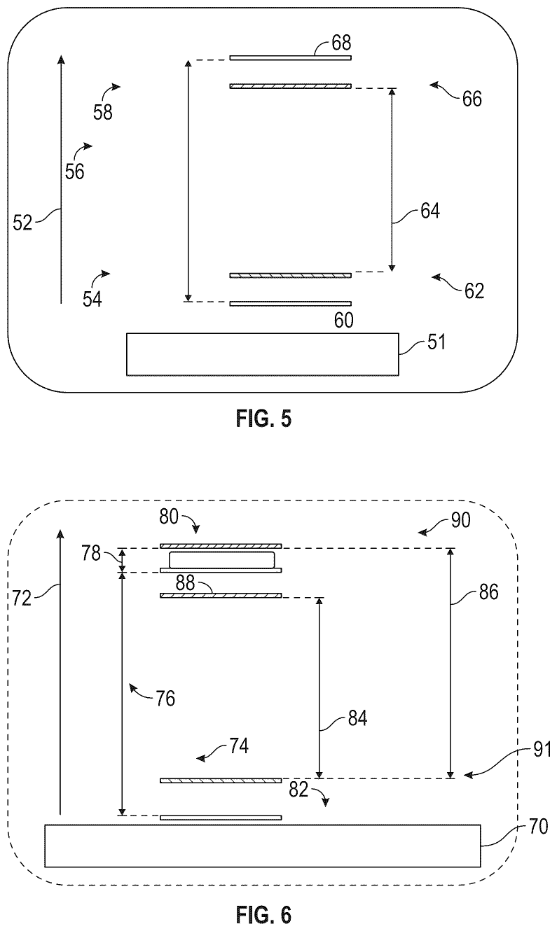

FIG. 5 is a chart of properties for a battery including electrolyte having a cyclic carbonate, linear carbonate, and a salt. Line 52 is energy (eV). Line 56 represents an energy window for a cathode 54 in an anode 58. LUMO is represented by 68. Numeral 66 represents μa. Line 64 represents Ecell. Numeral 62 represents μc. Numeral 60 represents HOMO. Numeral 51 represents ideal unknown electrolytes.

FIG. 6 is a chart illustrating desirable properties for electrolyte for use in a high-voltage system. Line 72 is energy (eV). Line 76 represents an energy window for a cathode 74 in an anode 80. Line 78 is SEI. LUMO is represented by 88. numeral 66 represents μa (Li, C or Si). Line 64 represents Ecell. Numeral 91 represents uc. Numeral 82 represents HOMO. Numeral 71 represents new solvents with intrinsic stability.

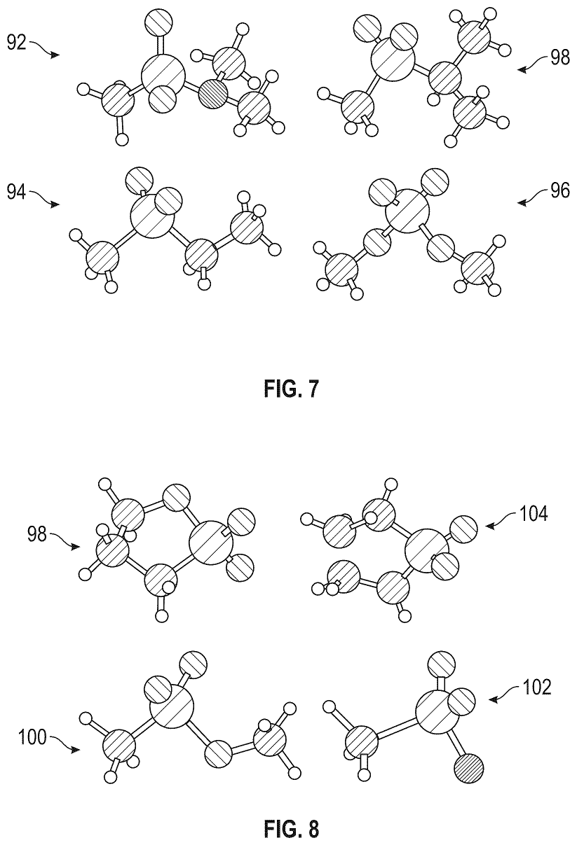

FIG. 7 illustrates the structure of organo-sulfur based solvents as good candidates for high-voltage operation of a battery with low HOMO, high and anodic stability as well as attractive thermal stability. Organo-sulfur based solvents may include DMMA 92, EMS 94, MIS 98, and DMS 96.

FIG. 8 illustrates the structure of organo-sulfur based solvents as good candidates for high-voltage operation of a battery with low HOMO, high and anodic stability as well as attractive thermal stability. Organo-sulfur based solvents may include PS 98, MMS 100, TMS 102, and MSF 104.

FIG. 9 is a chart of ESW for various organo-sulfur based solvents. The vertical or Y-axis 106 represents ESW (V vs Li/Li⁺) and the horizontal or X-axis 104 represents different organo-sulfur based solvents. Isolated solvent molecules are represented by 108, numeral 110 represents w/FEC, number 114 represents w/FEC & PF6-, number 112 represents w/FEC & LiPF₆. Line 136 represents oxidation potential FEC)=6.9V, and line 132 represents reduction potential E_{red} (FEC)=0.6V.

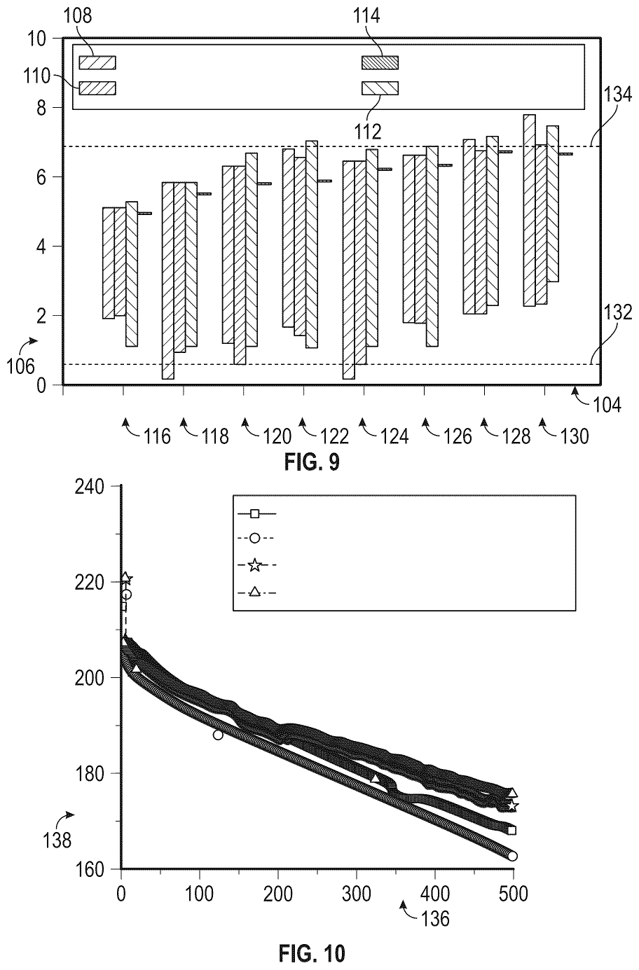

FIG. 10 is a chart illustrating the discharge capacity over a number of cycles for electrolyte including 1.2M LiPF6 and various solvents. The line including a square represents 1.2M LiPF6 in EC/EMC. The line including a circle represents 1.2M LiPF6 in FEC/EMS/TTE. The line including a star represents 1.2M LiPF6 in FEC/EMS/TTE+VC. The line including a triangle represents 1.2M LiPF6 in FEC/EMS/TTE+DTD.

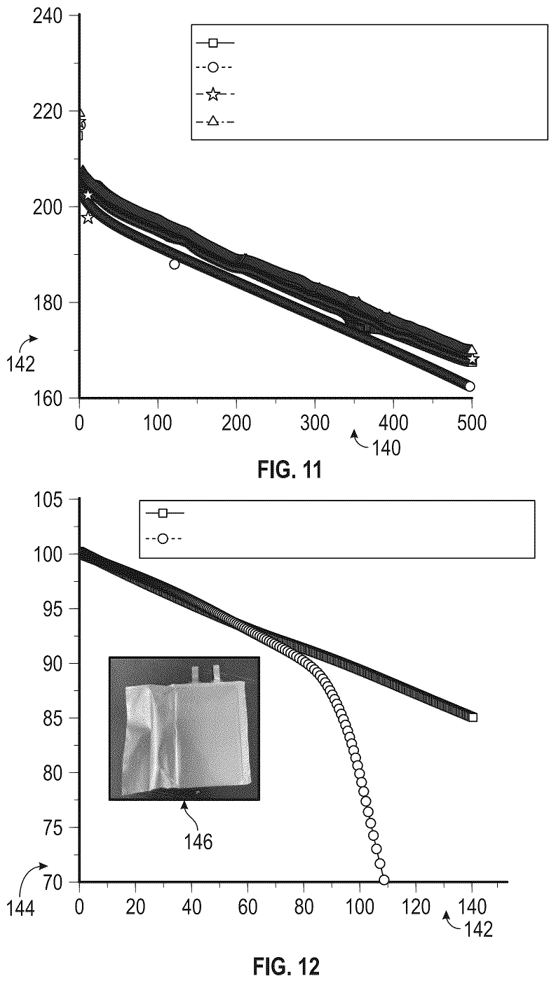

FIG. 11 is a chart illustrating the discharge capacity over a number of cycles for electrolyte including 1.2M LiPF6 and various solvents. The line including a square represents 1.2M LiPF6 in EC/EMC. The line including a square represents 1.2M LiPF6 in FEC/EMS/TTE. The line including a star represents 1.2M LiPF6 in FEC/EMS/TTE/LiFOB. The line including a triangle represents 1.2M LiPF6 in FEC/EMS/TTE/LiBOB.

FIG. 12 is a chart illustrating the capacity retention (%) of a 2.5 Ah pouch cell over a number of cycles for a battery including an electrolyte including 1.2M LiPF6 and various solvents. The line including a square represents 1.2M LiPF6 in EC/EMC. The line including a circle represents 1.2M LiPF6 in FEC/EMS/TTE+Additives.

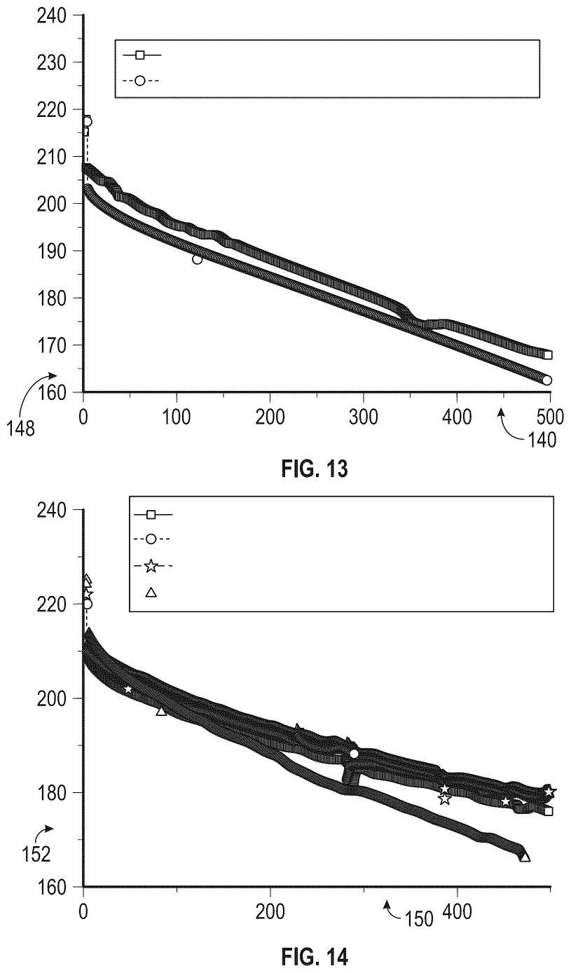

FIG. 13 the chart illustrating the discharge capacity (mAh/g) mean of four cells over a number of cycles for battery including an electrolyte including 1.2M LiPF6 and various solvents. The line including a square represents 1.2M LiPF6 in EC/EMC (Baseline Electrolyte). The line including a circle represents 1.2M LiPF6 in FEC/EMS/TTE.

FIG. 14 illustrates the capacity (mAh/g) over a number of cycles for batteries including different molar concentrations of LiPF6 with various solvents. The line including a square represents 1.0 M LiPF6+0.2M LiFSI FEC/EMS/TTE. The line including a circle represents 0.8 M LiPF6+0.4M LiFSI FEC/EMS/TTE. The line including a star represents 0.6 M LiPF6+0.6M LiFSI FEC/EMS/TTE. The line including a triangle represents 1.2M LiPF6 in EC/EMC (Baseline Electrolyte).

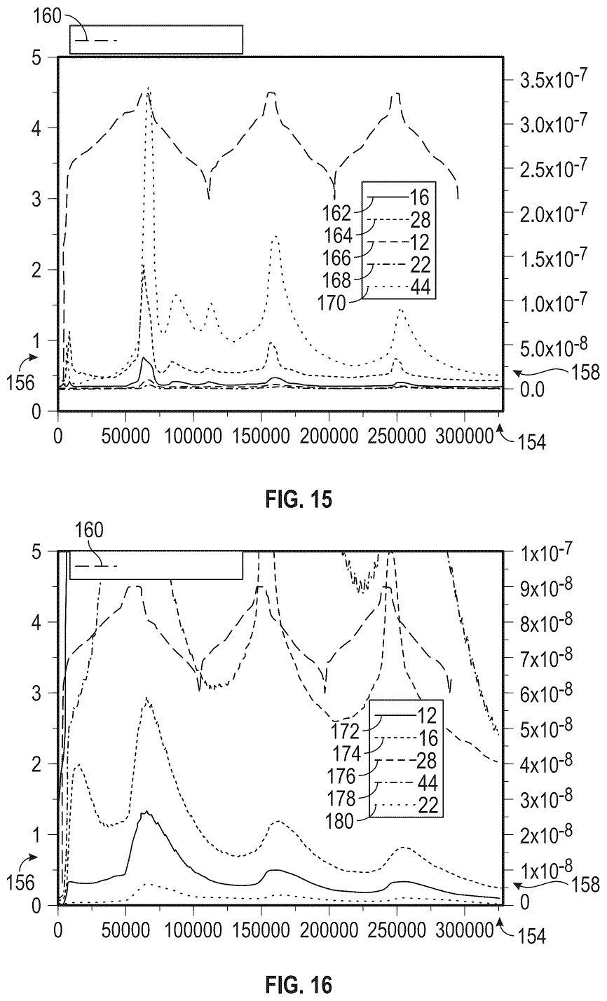

FIG. 15 is a chart of voltage and pressure over time at different voltages. A first vertical or Y-axis is voltage (V), a second vertical or Y-axis is pressure (Torr), and the horizontal or X-axis is time in seconds. Line 160 is voltage profile, line 162 is 16 V, 16 line 164 is 28 V, line 126 is 12 V, line 168 is 22 V, and line 170 is 44 V.

FIG. 16 is a chart of voltage and pressure over time at different voltages. A first vertical or Y-axis is voltage (V), a second vertical or Y-axis is pressure (Torr), and the horizontal or X-axis is time in seconds. Line 160 is voltage profile, line 172 is 12 V, line 174 is 16 V, line 176 is 12 V, line 178 is 44 V, and line 180 is 22 V.

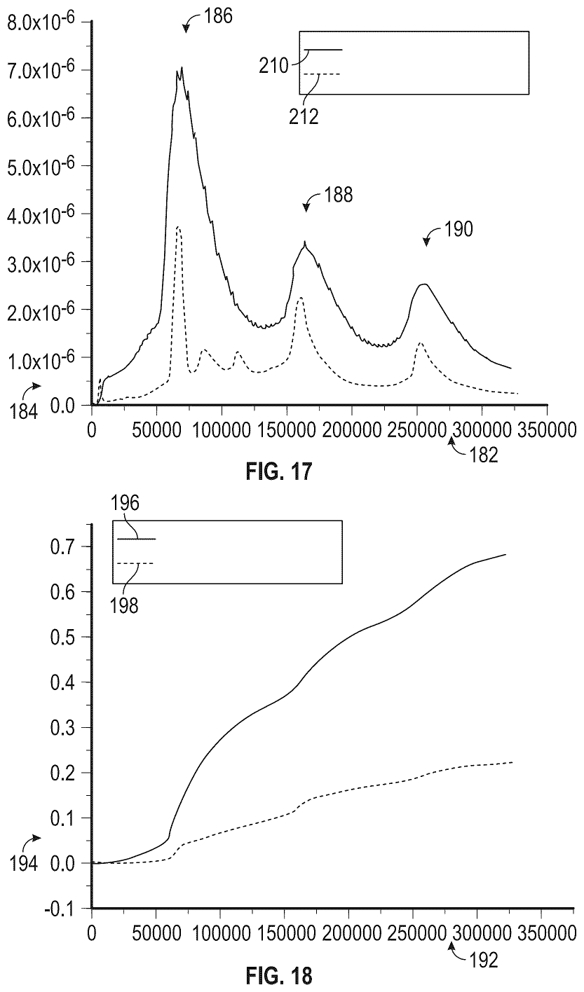

FIG. 17 is a chart illustrating the generation of carbon dioxide (umol) over time for batteries including different electrolytes, and solvents. The vertical or Y-axis 184 is CO2 (umol) and the horizontal or X-axis 182 is time in seconds. Line 210 represents FEC/EMS/TTE/LiPF6 and line 212 represents FEC/EMS/TTE/LiSI. Carbon dioxide showed peaks in a first cycle 186, second cycle 188, and third cycle 190.

FIG. 18 is a chart illustrating carbon dioxide generation over time for batteries including different electrolytes; The vertical or Y-axis 194 is CO2 (umol) and the horizontal or X-axis 192 is time in seconds. Line 196 represents FEC/EMS/TTE/LiPF6 and line 198 represents FEC/EMS/TTE/LiSI.

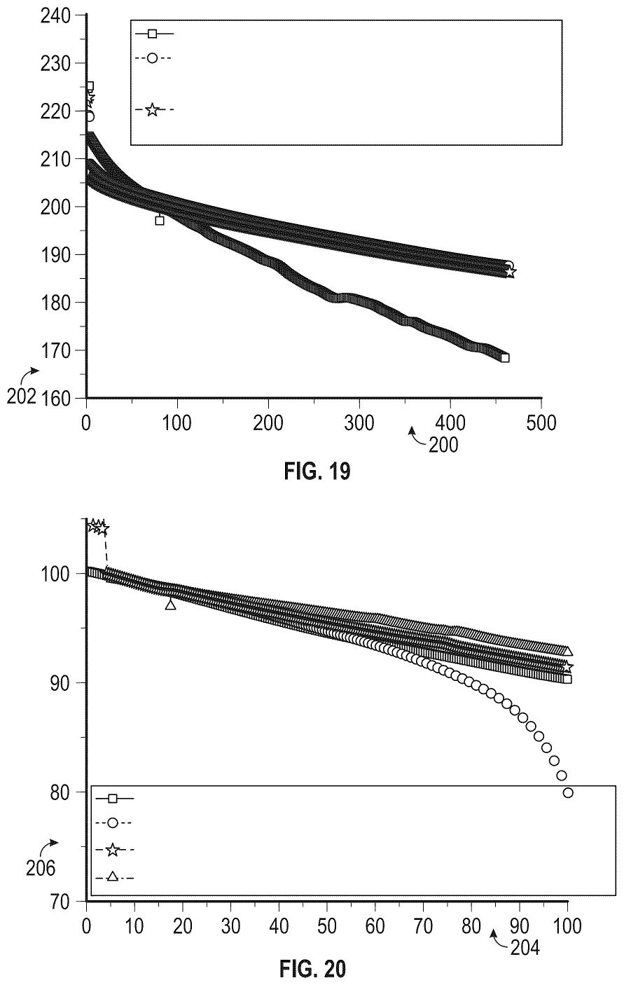

FIG. 19 is a chart illustrating the discharge capacity (mAh/g) over a number of cycles for batteries including different molar concentrations of LiPF6 with various solvents. The vertical or Y-axis 194 is discharge capacity (mAh/g) and the horizontal or X-axis 192 is cycle number. The line including a square represents 1.2M LiPF6 in EC/EMC (Baseline Electrolyte. The line including a circle represents 0.8M LiPF6+0.4M LiFSI in FEC/EMS/TTE (2:5:3 by v)+0.5% LiBOB. The line including a star represents 0.6M LiPF6+0.6M LiFSI in FEC/EMS/TTE (2:5:3 by v)+0.5% LiBOB.

FIG. 20 is a chart illustrating the capacity retention (%) over a number of cycles for batteries including different electrolytes. The vertical or Y-axis 206 is capacity retention (5) and the horizontal or X-axis 204 is cycle numbers.

FIG. 21 illustrates a system or product which may include a battery including an electrolyte.

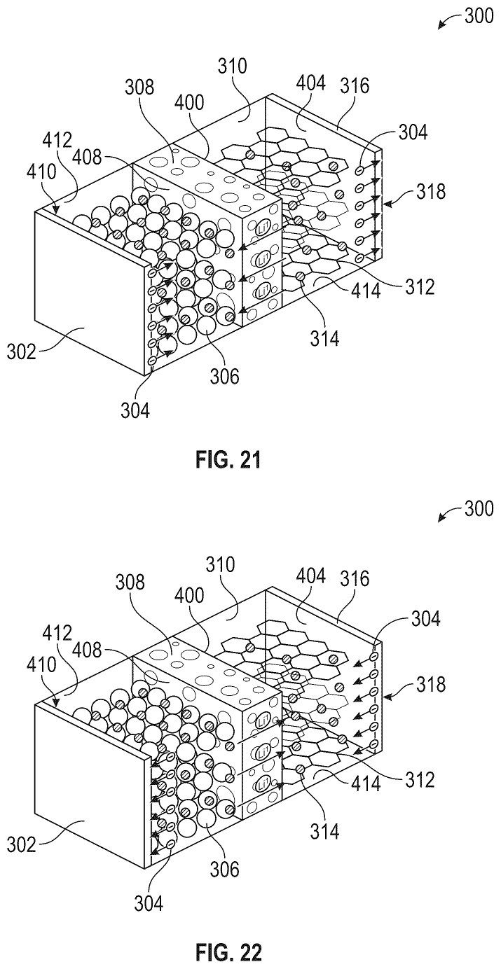

FIG. 22 illustrates a system or product which may include a battery including an electrolyte.

The solid-electrolyte interphase (SEI) is a passivating layer formed on the electrode/electrolyte interface, which, under ideal conditions, is stable during cycling, permits fast lithium transport and, at the same time, is an electronic insulator. In a number of variations, an electrolyte may include a cyclic carbonate as a SEI former. In a number of variations, an electrolyte may include 5% to 95% in volume ratio cyclic carbonate as a SEI former. In a number of variations, the cyclic carbonate may be

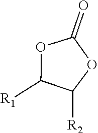

wherein, R1, and R2 are individually a hydrogen atom, or an alkyl or a methoxyl or a vinyl or a propargyl or an alkynyl or a benzyl group or a hydroxyl group, or an alkoxy group, or an alkenoxy group, or an alkynoxy group, or an aryloxy group, or a heterocyclyloxy group, or a heterocyclyalkoxy group; or a silyl group, or an siloxy group; or an oxo group; or a carboxyl group; a ester group; or a ether group; a cyano group, or a cyanoalkyl group; or a fluorine atom; or a fluorinated alkyl group or a fluorinated alkoxy group including CnHxFy or CH2CnHxFy or CH2OCnHxFy or CF2OCnHxFy group, wherein n is 1-5; m is 1-6; x is 0-11; and y is 1-11.

In a number of variations, the electrolyte may include a solvent comprising an organosulfur. In a number of variations, the organosulfur may be present in 5% to 95% in volume, and may have a formula of:

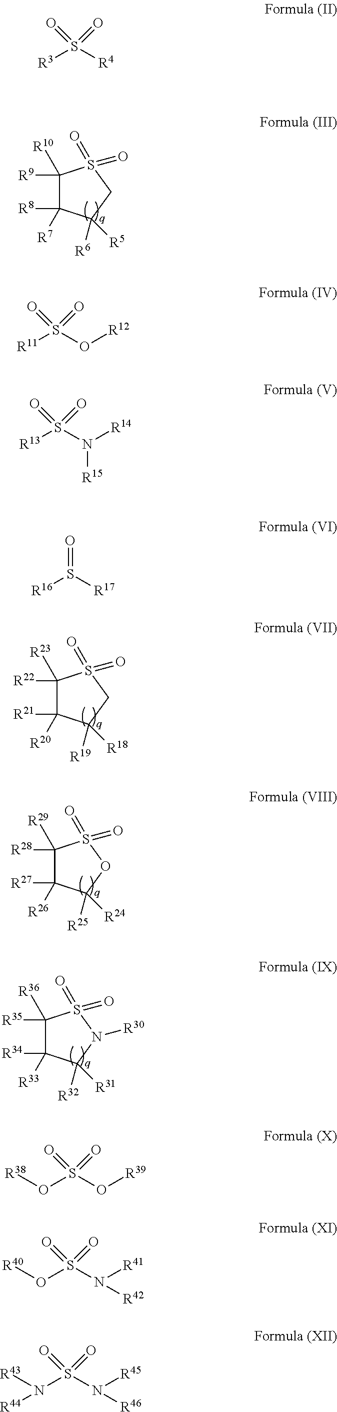

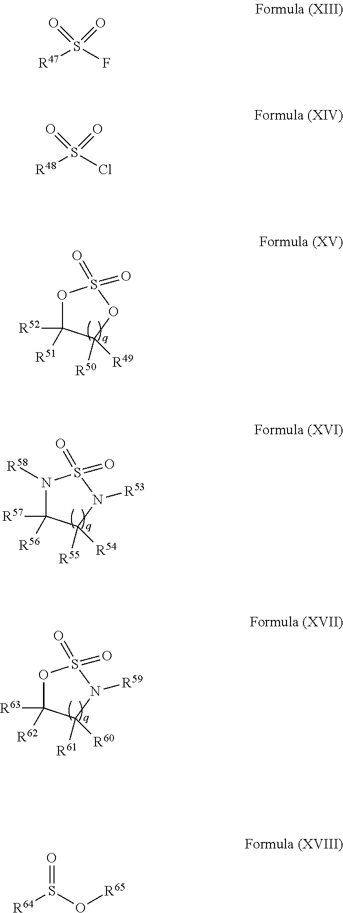

In a number of variations, the sulfonylimide may be present in a concentration range from 0.05M to 1.5M. In a number of variations, the electrolyte may include a lithium sulfonylimide salt may have the formula:

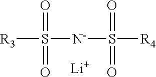

wherein, R4 and R⁵ are each individually either a fluorine (F) atom or a straight-chain C₁-C6 fluoroalkyl group.

In a number of variations, the electrolyte may include a lithium sulfonylimide salt may have the formula:

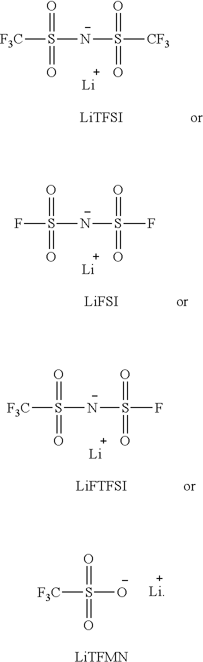

In a number of variations, the electrolyte may include 5% to 95% in volume of at least one of an ether or a fluorinated aromatic co-solvent. Examples of suitable fluorinated acyclic ethers include without limitation HCF2CF2CH2-O—CF2CF2H (CAS No. 16627-68-2) and HCF2CH2-O—CF2CF2H (CAS No. 50807-77-7).

In a number of variations, the electrolyte may include anti-corrosion additives to mitigate the aluminum or stainless-steel corrosion caused by sulfonylimide. In a number of variations, the electrolyte may include 0.1 to 5% in weight anti-corrosion additives. In a number of variations, the electrolyte may include anti-corrosion additives including at least one of: lithium 4,5-dicyano-2-trifluoromethylimidazole, lithium perchlorate, lithium difluorooxalatoborate, lithium bis(oxalato) borate, lithium tetrafluoroborate, lithium difluoroborate, lithium borate, lithium phosphate, lithium hexafluorophosphate, lithium difluorophsophate, lithium tetrafluorophosphate, lithium difluorooxalatophosphate, lithium tetrafluorooxalatophosphate, lithium tris(oxalato)phosphate, lithium arsenate, lithium hexafluoroarsenate, lithium difluoroarsenate, lithium tetrafluoroarsenate, lithium difluorooxalatoarsenate, lithium tetrafluorooxalatoarsenate, lithium tris(oxalato)arsenate, and their corresponding sodium salts:

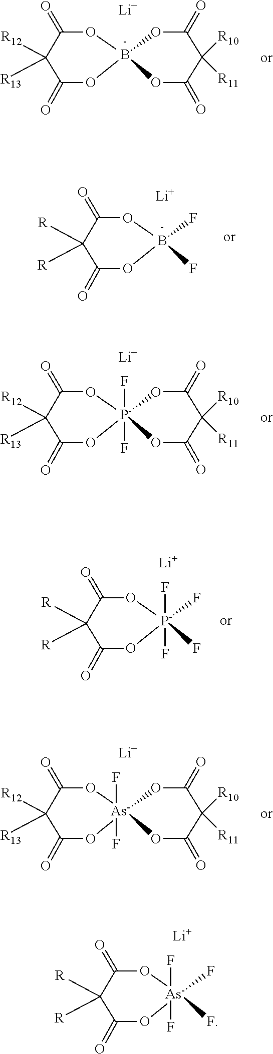

FIGS. 21 and 22 illustrate a system or a product 300 which may be a lithium-ion battery and methods of discharging and charging according to a number of variations. The product 300 which may be a battery cell which may include a first electrode 302, for example a cathode, and a first active material 310 on or adjacent to the first electrode 302. For a cathode electrode, the first active material 310 may be deposited on the first electrode 302 with a composition including metal oxides as the active material along with one or more conductive additives and one or more binders. The first active material 306 may include, but not limited to, at least one of lithium cobalt oxide (LiCoO₂), lithium manganese oxide (LiMn2O4), lithium iron phosphate (LiFePO4 or LFP), or lithium nickel manganese cobalt oxide (LiNiMnCoO2 or NMC). A second electrode 316, for example an anode, may be provided and a second active material 404 may be deposited on the second electrode 316. The second active material 404 may include, but not limited to, at least one of carbon-based materials such as graphite, silicon, or a combination of both, or lithium metal carbon materials. A separator 308 may be provided between the first electrode 302 and the second electrode 416 and may be constructed and arranged to allow the movement of lithium ions 314 therethrough. In FIG. 21 electrons 304 are moving from the first electrode 302 to the second electrode 316. In FIG. 22, electrons 304 are moving from the second electrode 316 to the second electrode 304. The system or product 300 may also include an electrolyte 310 as described herein.

While at least one variation has been presented in the foregoing detailed description, it should be appreciated that a vast number of variations exist. It should also be appreciated that the variation or variations are only examples, and are not intended to limit the scope, applicability, or configuration of the disclosure in any way. Rather, the foregoing detailed description will provide those skilled in the art with a convenient road map for implementing the illustrative variation or variations. It should be understood that various changes can be made in the function and arrangement of elements without departing from the scope of the disclosure as set forth in the appended claims and the legal equivalents thereof.

What is claimed is:

1. A product comprising:
an electrolyte comprising a lithium sulfonylimide and a solvent comprising an organosulfur.

2. The product as set forth in claim 1 wherein the lithium sulfonylimide has the formula: 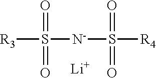
wherein, R4 and R5 are each individually either a fluorine (F) atom or a straight-chain C1-C6 fluoroalkyl group.

3. The product as set forth in claim 1 wherein the lithium sulfonylimide has the formula of:

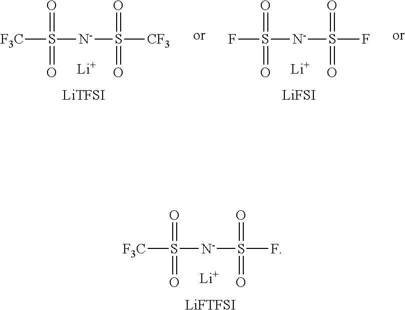

4. The product as set forth in claim 1 wherein the organosulfur comprises any one of the following formulas:

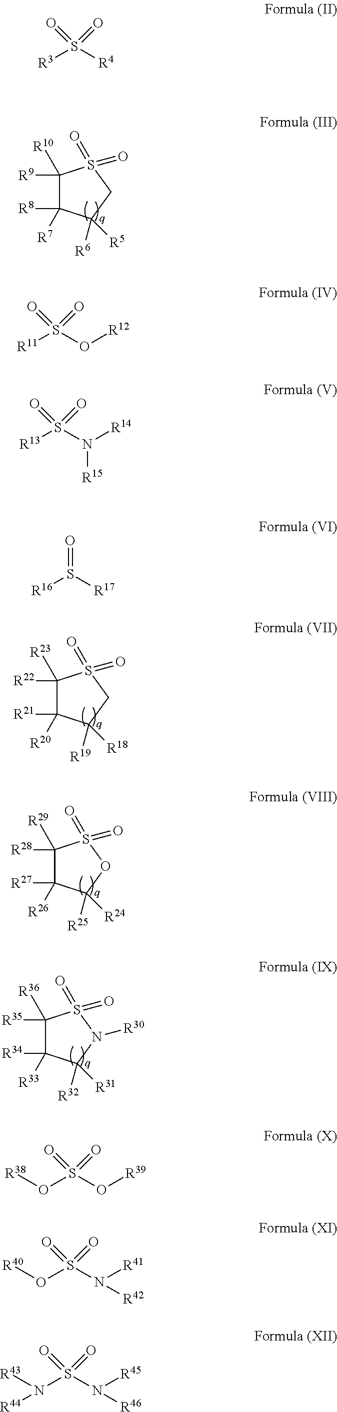

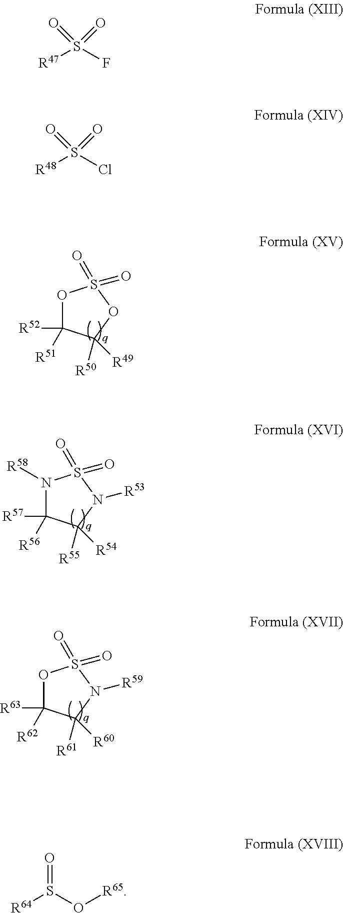

5. The product as set forth in claim 1 further comprising an ether or a fluorinated aromatic co-solvent.

6. The product as set forth in claim 1 further comprising cyclic carbonate having the formula: 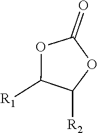
wherein, R1, and R2 are individually a hydrogen atom, or an alkyl or a methoxyl or a vinyl or a propargyl or an alkynyl or a benzyl group or a hydroxyl group, or an alkoxy group, or an alkenoxy group, or an alkynoxy group, or an aryloxy group, or a heterocyclyloxy group, or a heterocyclyalkoxy group; or a silyl group, or an siloxy group; or an oxo group; or a carboxyl group; a ester group; or a ether group; a cyano group, or a cyanoalkyl group; or a fluorine atom; or a fluorinated alkyl group or a fluorinated alkoxy group including CnHxFy or CH2CnHxFy or CH2OCnHxFy or CF2OCnHxFy group, wherein n is 1-5; m is 1-6; x is 0-11; and y is 1-11.

7. The product as set forth in claim 1 further comprising at least one of HCF2CF2CH2-O—CF2CF2H or HCF2CH2-O—CF2CF2H.

8. The product as set forth in claim 1 wherein the organosulfur comprises ethyl methyl sulfone.

9. The product as set forth in claim 1 further comprising an anti-corrosion additive comprising at least one of: lithium 4,5-dicyano-2-trifluoromethylimidazole, lithium perchlorate, lithium difluorooxalatoborate, lithium bis(oxalato) borate, lithium tetrafluoroborate, lithium difluoroborate, lithium borate, lithium phosphate, lithium hexafluorophosphate, lithium difluorophsophate, lithium tetrafluorophosphate, lithium difluorooxalatophosphate, lithium tetrafluorooxalatophosphate, lithium tris(oxalato)phosphate, lithium arsenate, lithium hexafluoroarsenate, lithium difluoroarsenate, lithium tetrafluoroarsenate, lithium difluorooxalatoarsenate, lithium tetrafluorooxalatoarsenate, lithium tris(oxalato)arsenate, or their corresponding sodium salts.

10. A product comprising:
an electrolyte comprising lithium sulfonylimide and a solvent comprising an organosulfur, a co-solvent comprising an ether or a fluorinated aromatic, a cyclic carbonate, and an anti-corrosion additive.

11. A system comprising:
a battery comprising an anode, cathode, and a separator between the anode and cathode, and an electrolyte; the electrolyte comprising a lithium sulfonylimide and a solvent comprising an organosulfur.

12. The system as set forth in claim 11 wherein the lithium sulfonylimide has the formula: 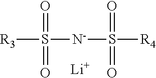
wherein, R4 and R5 are each individually either a fluorine (F) atom or a straight-chain C1-C6 fluoroalkyl group.

13. The system as set forth in claim 11 wherein the lithium sulfonylimide has the formula of:

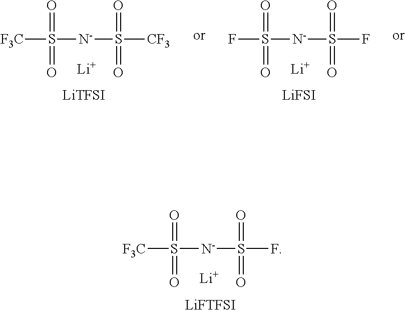

14. The system as set forth in claim 11 wherein the organosulfur comprises at least one of:

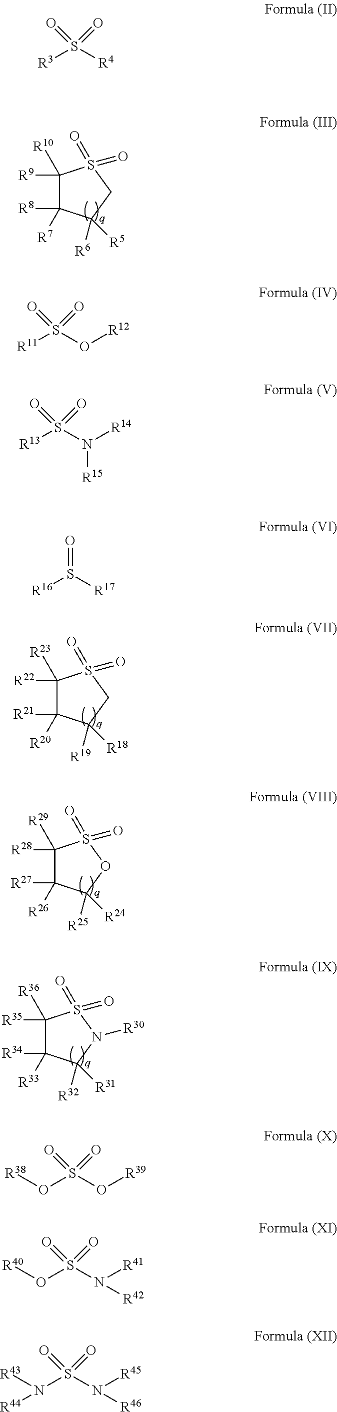

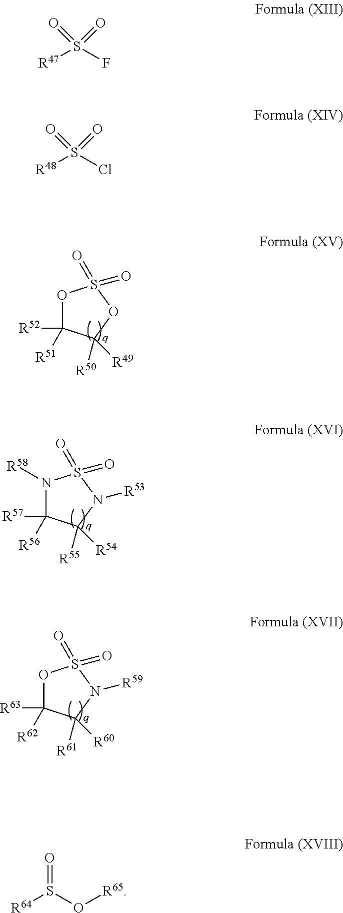

15. The system as set forth in claim 11 further comprising an ether or a fluorinated aromatic co-solvent.

16. The system as set forth in claim 11 further comprising a cyclic carbonate having the formula: 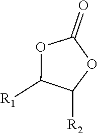
wherein, R1, and R2 are individually a hydrogen atom, or an alkyl or a methoxyl or a vinyl or a propargyl or an alkynyl or a benzyl group or a hydroxyl group, or an alkoxy group, or an alkenoxy group, or an alkynoxy group, or an aryloxy group, or a heterocyclyloxy group, or a heterocyclyalkoxy group; or a silyl group, or an siloxy group; or an oxo group; or a carboxyl group; a ester group; or a ether group; a cyano group, or a cyanoalkyl group; or a fluorine atom; or a fluorinated alkyl group or a fluorinated alkoxy group including CnHxFy or CH2CnHxFy or CH2OCnHxFy or CF2OCnHxFy group, wherein n is 1-5; m is 1-6; x is 0-11; and y is 1-11.

17. The system as set forth in claim 11 further comprising at least one of HCF2CF2CH2-O—CF2CF2H or HCF2CH2-O—CF2CF2H.

18. The system as set forth in claim 11 wherein the organosulfur comprises ethyl methyl sulfone.

19. The system as set forth in claim 11 further comprising an anti-corrosion additive comprising at least one of: lithium 4,5-dicyano-2-trifluoromethylimidazole, lithium perchlorate, lithium difluorooxalatoborate, lithium bis(oxalato) borate, lithium tetrafluoroborate, lithium difluoroborate, lithium borate, lithium phosphate, lithium hexafluorophosphate, lithium difluorophsophate, lithium tetrafluorophosphate, lithium difluorooxalatophosphate, lithium tetrafluorooxalatophosphate, lithium tris(oxalato)phosphate, lithium arsenate, lithium hexafluoroarsenate, lithium difluoroarsenate, lithium tetrafluoroarsenate, lithium difluorooxalatoarsenate, lithium tetrafluorooxalatoarsenate, lithium tris(oxalato)arsenate, or their corresponding sodium salts.

20. The system as set forth in claim 11 further comprising a co-solvent comprising an ether or a fluorinated aromatic, a cyclic carbonate, and an anti-corrosion additive.
